(19) United States
(12) Patent Application Publication
(10) Pub. No.: US 2010/0266898 A1
(43) Pub. Date: Oct. 21, 2010

(54) ELECTRODE FOR ELECTROCHEMICAL DEVICE

(76) Inventors: Taisuke Yamamoto, Nara (JP); Kazuya Iwamoto, Osaka (JP); Yasutaka Kogetsu, Osaka (JP)

Correspondence Address: MCDERMOTT WILL & EMERY LLP, 600 13TH STREET, NW, WASHINGTON, DC, 20005-3096, US

(21) Appl. No.: 12/742,195

(22) PCT Filed: Nov. 6, 2008
(86) PCT No.: PCT/JP2008/003219

§ 371 Date: May 10, 2010

(30) Foreign Application Priority Data
Nov. 9, 2007 (JP) 2007-291489

(51) Int. Cl. H01M 4/02; H01G 9/022; H01M 4/58; H01M 4/00

(52) U.S. Cl. 429/220; 361/502; 429/231.8; 429/223; 429/218.1; 429/221

(57) ABSTRACT

A problem to be solved by the invention is to provide an electrode for an electrochemical device which has a high capacity, suppresses the separation of an active material due to charge/discharge, and exhibits good cycle characteristics. To solve this problem, in the invention, an electrode 1 for an electrochemical device includes a current collector 2, an active material layer 4 formed over the current collector 2, and a thin layer 3 formed at least a part of the space between the current collector 2 and the active material layer 4. The active material layer 4 includes an active material which does not form a chemical bond with a component forming the current collector 2, and the like, and the thin layer 3 includes a component with a polarizability higher than that of the component forming the current collector 2.

### TECHNICAL FIELD

The present invention relates to an electrode used in electrochemical devices such as lithium ion secondary batteries and electrochemical capacitors, and further relates to improvement in adhesion between a current collector of an electrode and an active material layer thereof for electrochemical devices.

### BACKGROUND ART

In recent years, with developments made in portable devices such as personal computers and cell phones, there is an increasing demand for batteries as their power source. Also, high energy density and excellent cycle characteristics are demanded of batteries for the above-mentioned portable devices.

Therefore, in response to such a demand, high-capacity active materials are being newly developed. Among them, simple substances, oxides, or alloys of silicon (Si) and tin (Sn) are seen as promising as active materials with remarkably high capacities. For example, in a negative electrode for a lithium secondary battery described in PTL 1, a silicon oxide thin film on a current collector surface is used as an active material, and in a negative electrode for a lithium secondary battery described in PTL 2, a tin oxide thin film on a copper substrate surface is used as a negative electrode active material.

However, an active material using silicon exhibits volume expansion up to 440% due to battery charge/discharge reactions. Also, an active material using tin also exhibits marked volume expansion due to battery charge/discharge reactions, as with the case of silicon. Since such volume expansion causes a significantly large stress at the interface between the current collector and the active material, it may cause separation of the active material from the current collector.

To suppress separation of the active material, the adhesion between the current collector and the active material needs to be improved. Therefore, in an electrode for a lithium battery described in PTL 3, a thin film made of silicon or the like is formed directly on a surface of a current collector such as a copper foil, and further, the component (e.g., copper) forming the current collector is diffused into the active material. On the other hand, in an electrode for a lithium secondary battery described in PTL 4, an intermediate layer including Mo or W is formed between a current collector such as a copper foil and a thin film made of an active material such as silicon, and this intermediate layer suppresses excessive diffusion of the component forming the current collector into the active material thin film.

Also, for an electric double layer capacitor (electrochemical capacitor) described in PTL 5, the energy density is increased by using a non-aqueous electrolyte solution containing lithium ions as an electrolyte solution and using graphite capable of absorbing and releasing lithium, in place of carbon black, as an electrode active material.

### CITATION LIST

### Patent Literature

### [PTL 1] Japanese Laid-Open Patent Publication No. 2004-349237

### [PTL 2] Japanese Laid-Open Patent Publication No. 2002-110151

### [PTL 3] Japanese Patent Publication No. 3733067

### [PTL 4] Japanese Laid-Open Patent Publication No. 2002-373644

### [PTL 5] Japanese Laid-Open Patent Publication No. 2005-093777

### SUMMARY OF INVENTION

### Technical Problem

According to the electrode for a lithium battery described in PTL 3, the adhesion between the active material and the current collector can be increased by the diffusion of the component of the current collector into the active material layer. However, the diffusion of the component of the current collector decreases charge/discharge capacity.

On the other hand, as in the electrode for a lithium secondary battery described in PTL 4, when the diffusion of the component forming the current collector into the active material layer is suppressed, a decrease in charge/discharge capacity can be suppressed, but it becomes difficult to increase the adhesion between the current collector and the active material. Also, in the electrode for a lithium secondary battery described in PTL 4, the adhesion between the intermediate layer and the active material layer is increased by roughening the surface of the intermediate layer. However, this may be insufficient for suppressing separation of the active material layer when the active material layer exhibits an extremely large volume expansion.

Also, if separation of the active material from the current collector can be prevented while also suppressing diffusion of the component of the current collector into the active material layer to prevent a decrease in charge/discharge capacity, the use of silicon or tin as the electrode active material in the electrochemical capacitor described in PTL 5 is expected to provide increased energy density, as with the case of lithium ion secondary batteries.

The invention solves the above-described problems, and an object of the invention is to provide an electrode for an electrochemical device which has a high capacity, suppresses the separation of an active material due to charge/discharge, and exhibits good cycle characteristics.

### Means for Solving the Problem

To achieve the above object, the electrode for an electrochemical device according to the invention includes a current collector, a thin layer formed on at least a part of a surface of the current collector, and an active material layer formed on a surface of the thin layer. The active material layer comprises an active material that does not form a chemical bond with a component forming the current collector, and the thin layer consists essentially of a component with a polarizability higher than that of the component forming the current collector.

The electrode for an electrochemical device uses, as the active material, a component that does not form a chemical bond with the component forming the current collector. Therefore, the electrode for an electrochemical device can suppress the diffusion of the current collector component into the active material layer and a resultant decrease in charge/discharge capacity.

Also, in the electrode for an electrochemical device, the thin layer formed between the current collector and the active material layer comprises a component with a polarizability higher than that of the component forming the current collector. Thus, the adhesion between the active material layer and the thin layer is increased due to the following reason.

The adhesion between the active material layer and the current collector and the adhesion between the active material layer and the thin layer are believed to result from physical bonding, i.e., van der Waals force, provided that no chemical bond with the active material layer is formed. The interaction energy Uᵥ(r)/eV between the active material and the current collector or thin layer is given by the following formula.

[Formula 1]

In the formula, α_{A} represents the polarizability [Å³] of the active material, while α_{B} represents the polarizability [Å³] of the current collector or thin layer. r represents the center-to-center distance [Å] between the component (atom or molecule) forming the active material layer and the component (atom or molecule) forming the current collector or thin layer. I_{A} represents the ionization energy [eV] of the active material, while I_{B} represents the ionization energy [eV] of the current collector or thin layer.

According to the table on page 24 of Denkikagaku Binran (Electrochemical Manual) fifth edition (edited by The Electrochemical Society of Japan, 2000), the first ionization energies of metal elements used for current collectors and active materials are approximately 6 to 8 eV. Thus, “I_{A}I_{B}/(I_{A}+I_{B})” in the right-hand side of the above formula is approximately 2.2 to 5.3 eV. Also, since the polarizabilities of metal elements used for current collectors and active materials are as high as approximately 5 to 30 Å³, “3α_{A}α_{B}/2r⁶” in the right-hand side of the above formula is a main part that determines the interaction energy Uᵥ(r)/eV. That is, the polarizability of the active material and the polarizability of the current collector or thin layer play a significant role in the determination of interaction energy Uᵥ(r).

According to the above formula, when the polarizability α_{A} of the active material is the same, the higher the polarizability α_{B} of the current collector or thin layer, the larger the interaction energy Uᵥ(r), and the stronger the adhesion between the active material layer and the current collector or thin layer. Thus, heightening the polarizability of the component forming the thin layer, compared with the component forming the current collector, increases the interaction energy Uᵥ(r) between the active material and the thin layer, thereby making it possible to increase the adhesion between the active material and the thin layer.

Further, in the electrode for an electrochemical device, the active material layer preferably comprises one selected from the group consisting of oxides, nitrides and carbides of silicon, and oxides, nitrides and carbides of tin.

In the electrode for an electrochemical device, preferably, the active material layer is composed of an oxide of silicon represented by the formula: SiOₓ where 0<x<1.2 and x represents an atomic ratio of oxygen, the current collector is composed of copper, and the thin layer is composed of Ti.

### ADVANTAGEOUS EFFECTS OF INVENTION

The invention can provide an electrode capable of suppressing the diffusion of the component forming the current collector into the active material layer, increasing the adhesion between the current collector and the active material layer, and suppressing the deformation of the electrode plate and the separation of the active material due to battery charge/discharge reactions.

Therefore, when the electrode for an electrochemical device according to the invention is used as an electrode for a lithium ion secondary battery, the capacity of the battery can be heightened and the cycle characteristics can be improved.

Also, when the electrode for an electrochemical device according to the invention is used as an electrode for an electrochemical capacitor, in particular, in place of a conventional graphite electrode, the resultant electrochemical capacitor can provide high energy density not achieved with a conventional electrode such as a graphite electrode.

### BRIEF DESCRIPTION OF DRAWING(S)

FIG. 1 is a schematic cross-sectional view showing an electrode for an electrochemical device according to one embodiment of the invention;

FIG. 2A is a schematic diagram for showing how an active material layer is formed, in which a state after the formation of a thin layer is illustrated;

FIG. 2B is a schematic diagram for showing how an active material layer is formed, in which a state after the formation of the active material layer is illustrated;

FIG. 3 is a schematic cross-sectional view showing an example of a layered lithium ion secondary battery;

FIG. 4 is a partially cut-away perspective view showing one embodiment of an electrochemical capacitor;

FIG. 5A is a front view for showing a vapor deposition device used in an Example; and

FIG. 5B is a side view for showing the vapor deposition device used in the Example.

### DESCRIPTION OF EMBODIMENTS

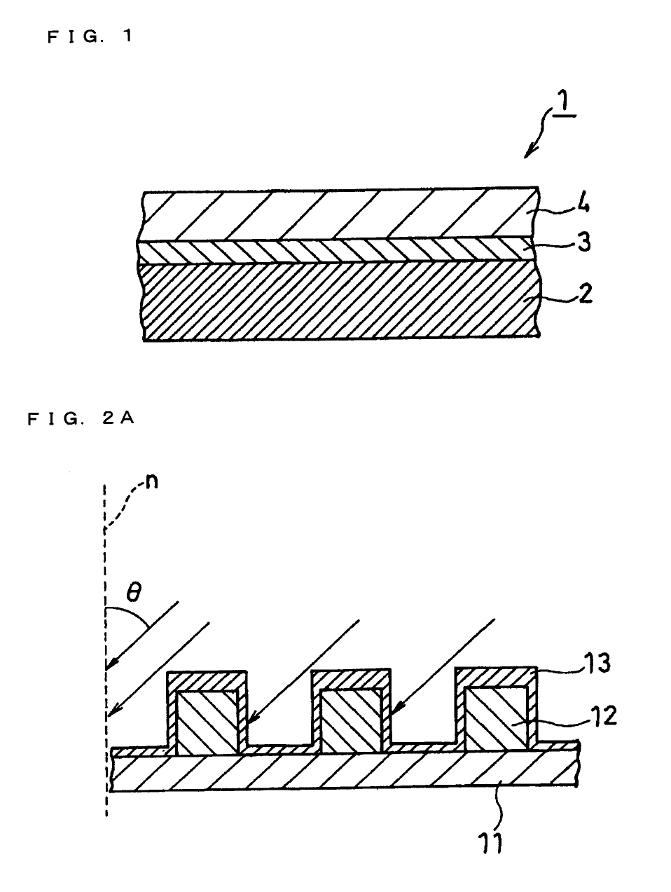

FIG. 1 is a schematic cross-sectional view showing one embodiment of an electrode for an electrochemical device according to the invention.

With reference to FIG. 1, an electrode 1 for an electrochemical device includes a current collector 2, a thin layer 3 formed so as to cover the surface of the current collector 2, and an active material layer 4 formed on the thin layer 3.

The current collector 2 is a member on the surface of which the thin layer 3 and the active material layer 4 are supported.

The current collector 2 is made of a material which does not form a chemical bond with an active material (described later) and which is selected from various current collector materials that are used in the field of electrochemical devices, in particular, as current collectors for electrodes of lithium ion secondary batteries and current collectors for polarizable electrodes of electrochemical capacitors.

Preferably, the component which does not form a chemical bond with an active material needs to be a metal which does not reduce lithium ions. If the current collector 2 reacts with lithium ions, the active material layer 4 expands and contracts, thereby causing separation of the active material layer 4 from the current collector 2 or deformation of the current collector 2.

Examples of the material forming the current collector include copper, copper alloys, nickel, nickel alloys, a binary alloy of copper and nickel, and stainless steel. Among them, in terms of workability and mechanical strength, copper, nickel, and stainless steel are preferable, and copper is particularly preferable.

The copper or copper alloy current collector is preferably copper foil, i.e., rolled copper foil, rolled copper alloy foil, electrolytic copper foil, or electrolytic copper alloy foil. Also, the copper foil may be provided with a surface roughness pattern in terms of further increasing the adhesion of the thin layer 3 or the active material layer 4.

The current collector 2 may be composed of a polymer film and a layer of such a current collector material as described above formed on a surface of the polymer film.

While the thickness of the current collector 2 is not particularly limited, the common thickness is, for example, 1 to 50 μm.

The current collector 2 may have a smooth surface. However, in terms of increasing the adhesive strength between the current collector 2 and the thin layer 3 and the active material layer 4, the current collector 2 preferably has large surface roughness. Specifically, the current collector 2 is preferably a foil with surface roughness (rough foil) made of such a current collector material as described above.

The surface roughness Rₐ of the current collector 2 is preferably, but not limited to, for example, 0.3 to 0.5 μm. As used herein, “surface roughness Rₐ” refers to “arithmetic mean roughness Rₐ” defined in Japan Industrial Standard JIS B 0601:₂₀₀₁. Also, surface roughness Rₐ can be measured, for example, with a surface roughness meter.

When the surface roughness Rₐ of the current collector 2 is 0.3 to 0.5 μm, sufficient gaps can be formed between the current collector 2 and the adjacent thin layer 3 or the active material layer 4 in a more reliable manner, thereby making it possible to increase the adhesion of the thin layer 3 or the active material layer 4. If the surface roughness Rₐ of the current collector 2 exceeds 0.5 μm, the thickness of the current collector 2 may become excessive.

The thickness of the current collector 2 is suitably set depending on the application of the electrochemical device, etc.

The thin layer 3 is formed between the current collector 2 and the active material layer 4. The thin layer 3 may be formed on the whole surface of the current collector 2, as illustrated in FIG. 1, or may be formed only on the part of the surface of the current collector 2 over which the active material layer 4 is to be formed.

The material forming the thin layer 3 is a component with a polarizability higher than that of the component forming the current collector 2.

For example, when the component foaming the current collector 2 is copper or a copper alloy, the material forming the thin layer 3 is a metal or an alloy of two or more metals selected from the group consisting of Ti, Ni, Co, Fe, Mn, Cr, V, Sc, Y, Zr, and Rh. Such metals and alloys have higher polarizabilities than copper and copper alloys. Hence, such a metal or alloy is preferable as the material forming the thin layer 3 used with the current collector 2 made of copper or a copper alloy.

In this case, among the above list, Ti, Sc, Y, and alloys of two or more such metals are preferable as the material forming the thin layer 3, and Ti is more preferable.

When the component forming the current collector 2 is nickel or a nickel alloy, the material forming the thin layer 3 is a metal or an alloy of two or more metals selected from the group consisting of Cr, V, Ti, Y, Zr, Nb, and Sc. Such metals and alloys have higher polarizabilities than nickel and nickel alloys. Thus, such a metal or alloy is preferable as the material forming the thin layer 3 used with the current collector 2 made of nickel or a nickel alloy.

Also, when the component forming the current collector 2 is stainless steel made of Fe, Ni, and Cr, the material forming the thin layer 3 is a metal or an alloy of two or more metals selected from the group consisting of V, Ti, Y, Zr, Nb, and Sc. Such metals and alloys have higher polarizabilities than stainless steel. Hence, such a metal or alloy is preferable as the material forming the thin layer 3 used with the current collector 2 made of stainless steel.

The method for forming the thin layer 3 is not particularly limited, and various thin-film formation methods such as vapor deposition, sputtering, chemical vapor deposition (CVD), and plating can be used. In particular, vapor deposition, sputtering, CVD, or plating allows the thickness of the thin layer to be controlled easily while ensuring adhesion between the current collector and the thin layer.

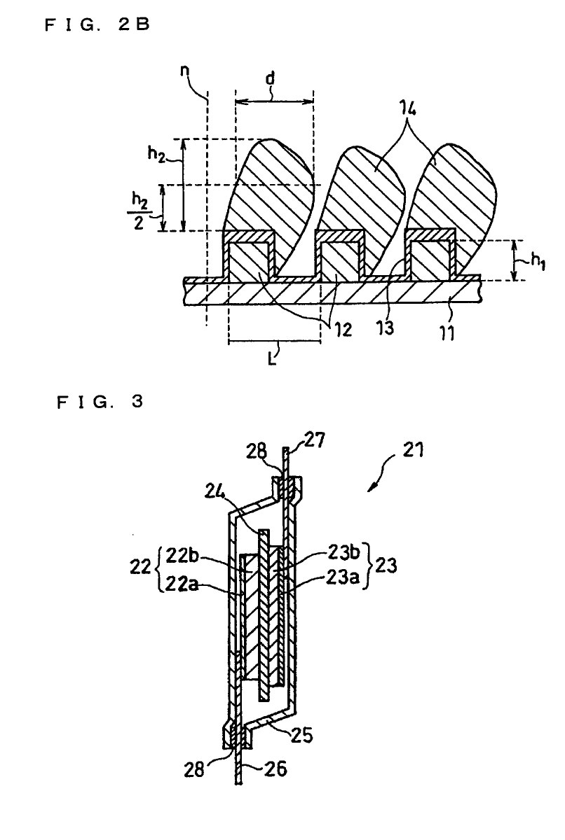

The active material layer 4 comprises a layer of an active material on the surface of the thin layer 3 (see FIG. 1), or comprises a plurality of columns of an active material on the surface of the thin layer 3, as described later (see FIG. 2B).

The active material used to form the active material layer 4 is a material that does not form a chemical bond, such as a covalent bond, an ionic bond, or a metallic bond, with the current collector 2. The chemical bond formed with the current collector 2 includes diffusion of the component forming the current collector 2 in the active material layer 4 (see PTL 3).

Examples of active materials that do not form a chemical bond with the current collector 2 include silicon (simple substance), silicon oxides, silicon nitrides, silicon carbides, silicon composite oxides, tin (simple substance), tin oxides, tin nitrides, tin carbides, and tin composite oxides.

Silicon oxides are represented by, for example, the compositional formula SiOₓ. In this compositional formula, x represents the atomic ratio of oxygen and 0<x<1.2. It is noted that as the oxygen ratio increases, the irreversible capacity of the electrode tends to increase. As such, in practical use, preferably 0.1<x<1. Silicon nitrides are represented by, for example, the compositional formula SiN_{b}. In this compositional formula, b represents the atomic ratio of silicon and 0<b<4/3.

Tin oxides are represented by, for example, the compositional formula SnO_{y}. In this compositional formula, y represents the atomic ratio of oxygen and 0<y<2. Tin composite oxides are represented by, for example, SnB_{z}P_{1-z}O₃. In this compositional formula, z represents the atomic ratio of boron and 0<z≦1.

Other oxides than the above-listed ones include, for example, V₂O₅ and LiCoO₂. Also, other nitrides than the above-listed ones include, for example, LiCoN.

Since these active materials do not form a chemical bond with the current collector 2, they do not form a layer in which the component forming the current collector 2 and the active material are mixed together, as described in PTL 3. Hence, they do not cause problems such as decreased charge/discharge capacity due to the diffusion of the component forming the current collector 2 in the active material layer 4.

Also, the active material may be aluminum simple substance. For example, in the case of the current collector 2 made of copper foil, when an aluminum layer is formed at a temperature of 500° C. or less as the active material layer 4, it is possible to prevent alloying of aluminum with copper. Thus, aluminum can be used as the active material for the electrochemical device of the invention.

The active material may be in monocrystalline form, or may be in polycrystalline form containing a plurality of crystallites. Also, it may be microcrystalline particles with a crystallite size of 100 nm or less, or may be amorphous.

The thickness of the active material layer 4 is not particularly limited; however, generally, it is preferably 5 μm or more and 100 μm or less, and more preferably 5 μm or more and 50 μm or less. Setting the thickness of the active material layer 4 to 5 μm or more can ensure sufficient energy density. Also, setting the thickness of the active material layer 4 to 100 μm or less allows the production efficiency to be maintained.

FIG. 2A and FIG. 2B are schematic diagrams for showing how an active material layer is formed in another embodiment of the electrode for an electrochemical device according to the invention. FIG. 2A illustrates a state after a thin layer 13 is formed on the surfaces of protrusions 12 of a current collector 11, while FIG. 2B illustrates a state after an active material layer is formed.

With reference to FIG. 2A and FIG. 2B, the current collector 11 has a plurality of the protrusions 12 on the surface. The protrusions 12 have a predetermined height h₁ and are regularly arranged on the surface of the current collector 11 at a predetermined interval. Also, the thin layer 13 is formed on the surface of the current collector 11 so as to conform to the surface shape of the protrusions 12. The thin layer 13 may be formed only on the surfaces of the protrusions 12 on the surface of the current collector 11.

An active material is formed as a plurality of columns 14 on the thin layer 13 on the surfaces of the protrusions 12. An active material layer comprises the plurality of columns 14 formed on the thin layer 13 on the surfaces of the respective protrusions 12.

In this way, when the active material columns 14 are formed only over the surfaces of the protrusions 12, not over the whole surface of the current collector 11, gaps are formed between the adjacent columns 14. In this case, even when the active material expands during charge/discharge, the stress created by the expansion between the columns 14 and between the columns 14 and the thin layer 13 and the protrusions 12 can be alleviated by the gaps.

The protrusions 12 on the surface of the current collector 11 can be formed, for example, by electrolytic plating. According to electrolytic plating, first, the current collector 11 is masked by applying a photoresist thereto, and then exposed to light and etched to form a pattern corresponding to the protrusions 12 on the current collector 11. Subsequently, the same component as the component forming the current collector 11 is electro-deposited on the surface area of the current collector 11 not covered with the photoresist by electrolytic plating, to form the protrusions 12 on the surface of the current collector 11.

In the above-described example, the protrusions 12 are described as having a rectangular cross-sectional shape in a front view to provide a simple description, but the shape of the protrusions 12 is not particularly limited. For example, the protrusions 12 which are polygonal, circular, oval and the like in a plan view are preferable in terms of the ease of production.

The method for forming the thin layer 13 on the surface of the current collector 11 and the protrusions 12 is not particularly limited. For example, various thin-film formation methods such as vapor deposition, sputtering, chemical vapor deposition (CVD), and plating may be used in the same manner as in the formation of the thin layer 3 of the electrode 1 for an electrochemical device illustrated in FIG. 1.

Also, the active material columns 14 can be produced by various methods; however, in terms of productivity, they are preferably produced by a vacuum process such as vapor deposition. Specifically, the columns 14 are formed by controlling the incident angle θ of the particles to be deposited, depending on the shape, interval, and height h₁ of the protrusions 12 of the current collector 11.

It should be noted that the active material does not need to be deposited onto the side faces of the protrusions 12 and the surface of the current collector 11 between the adjacent protrusions 12. Thus, by suitably controlling the incident angle θ of the particles to be deposited, and making an adjustment so that the side faces of the protrusions 12 and the surface of the current collector 11 are shadowed when seen from a vapor deposition source, it is possible to suppress the deposition of the active material onto the side faces of the protrusions 12 and the surface of the current collector 11. Also, by depositing the active material mainly onto the top surfaces of the protrusions 12, gaps can be formed between the adjacent columns 14.

With reference to FIG. 2A, the protrusions 12 (height h₁) are regularly arranged on the surface of the current collector 11 at a fixed interval L. Also, the thin layer 13 is formed on the whole surface of the current collector 11. When the particles to be deposited are projected onto the current collector 11 slantwise at an angle θ with respect to the direction n of the normal to the plane of the current collector, shadows are formed on the current collector 11 due to the height of the protrusions 12. Specifically, due to the shadowing effect, the active material particles are not deposited onto parts of the current collector 11 with a length of h₁×tan θ. Thus, by controlling the height h₁ and interval L of the protrusions 12 and the incident angle θ of the deposition particles so that L<h₁×tan θ, the active material columns 14 can be deposited onto the protrusions 12 with gaps between the columns 14.

The average porosity of the whole active material layer can be calculated by observing its cross-sections from a plurality of directions with an electron microscope. Also, the average porosity can be easily obtained from the weight of the active material layer per unit area, the thickness thereof, and the active material density. Further, the porosity can be measured more accurately by methods such as gas adsorption and mercury intrusion porosimetry. Also, the in-plane porosity in a plane parallel to the plane of the current collector can be obtained by observing a cross-section of a plane parallel to the plane of the current collector with an electron microscope, and calculating the ratio of the area of the pores to the total area.

As used herein, the plane of the current collector refers to the flat plane obtained by averaging the height of the surface roughness of the current collector, and the direction of the normal to the plane of the current collector refers to the direction perpendicular to the plane of the current collector. When the protrusions 12 of the same shape are provided regularly as in the current collector 11, the plane of the current collector is the plane parallel to the flat plane connecting the top surfaces or the highest points of the respective protrusions 12.

In the case of the above-described production method, the active material is often formed as the columns 14. While the diameter d of the columns 14 is not particularly limited, it is preferably 50 μm or less, and more preferably 1 to 20 μm, in terms of preventing the columns 14 from becoming cracked due to expansion during charge. The diameter d of the columns 14 can be obtained, for example, as the average value of the diameters of a given number of (e.g., 2 to 10) columns 14 at the center height (h₂/2) thereof (see FIG. 2B). The center height of the columns 14 is the height of the columns 14 in the direction n of the normal to the current collector 11. Also, the diameter d is the width of the columns 14 in the direction parallel to the plane of the current collector.

Also, the shape of the columns 14 is not limited to the shape shown in FIG. 2B. For example, the columns 14 may have a shape having one or more bends in the direction of the height h₁. The respective regions of the columns 14 divided by the bends (the respective columnar parts) may be slanted in the same manner or in different manners. Further, when the current collector 11 has an active material layer on each surface thereof, the respective regions of the columns divided by the bends (the respective columnar parts) on both surfaces of the current collector 11 may be slanted in the same manner or in different manners.

The protrusions 12 on the current collector 11 have a regular arrangement pattern, which makes it possible to control the space necessary for alleviating the stress created by the expansion and contraction of the active material. The size of the regular arrangement pattern of the protrusions 12 is not particularly limited. However, in terms of preventing electrode deformation due to the expansion stress of the columns 14, the width d of the protrusions 12 is preferably 50 μm or less, and more preferably 1 to 20 μm. The height h₁ of the protrusions 12 is preferably 30 μm or less, and more preferably 3 μm to 20 μm, in terms of the strength of the protrusions 12.

The method for forming the protrusions 12 on the current collector 11 is not particularly limited. For example, plating and roll pressing are used. According to plating, the current collector 11 is masked with a resist, and then the protrusions 12 are formed by plating. Plating methods include electroplating and electroless plating. According to electroless plating, a metal coating is also formed on a mask which is not made of metal. The metal coating becomes an obstacle in removing the resist after the formation of the pattern, so the resist tends to remain unremoved. Hence, electroplating is preferable since a metal coating is not formed on a non-metal.

According to roll pressing, the protrusions 12 are formed by mechanically working a metal foil, serving as the current collector 11, with a roller having grooves in the surface to cause plastic deformation. The line pressure of the roller press is preferably 0.5 to 5 t/cm. When the line pressure is lower than 0.5 t/cm, satisfactory protrusion shape may not be obtained. If it exceeds 5 t/cm, the current collector 11 may break.

FIG. 3 is a schematic cross-sectional view showing an embodiment of an electrochemical device using the electrode for an electrochemical device according to the invention, in which the electrode for an electrochemical device according to the invention is applied to the negative electrode for a lithium ion secondary battery.

A lithium ion secondary battery 21 includes an electrode group composed of a positive electrode 22, a negative electrode 23, and a separator 24 interposed therebetween. The electrode group and an electrolyte are contained in an exterior case 25. Also, the electrolyte is impregnated into the separator 24.

The positive electrode 22 comprises a positive electrode current collector 22a and a positive electrode active material layer 22b supported on a surface of the positive electrode current collector 22a. The negative electrode 23 comprises a negative electrode current collector 23a and an active material layer 23b supported on a surface of the negative electrode current collector 23a. One end of a positive electrode lead 26 and one end of a negative electrode lead 27 are connected to the positive electrode current collector 22a and the negative electrode current collector 23a, respectively. The other end of the positive electrode lead 26 and the other end of the negative electrode lead 27 are drawn out of the exterior case 25. The opening of the exterior case 25 is sealed with a resin material 28.

The positive electrode active material layer 22b releases lithium ions upon charge and absorbs the lithium ions released by the active material layer 23b upon discharge. The active material layer 23b absorbs the lithium ions released by the positive electrode active material upon charge and releases the lithium ions upon discharge.

The electrode for an electrochemical device according to the invention is used as the negative electrode of the lithium ion secondary battery 21. The other constituent components of the lithium ion secondary battery 21 than the negative electrode are not particularly limited.

Examples of the positive electrode active material used to form the positive electrode active material layer 23b include, but are not limited to, lithium-containing transition metal oxides such as lithium cobaltate (LiCoO₂), lithium nickelate (LiNiO₂), and lithium manganate (LiMn₂O₄). Also, the positive electrode active material layer 23b may be composed only of a positive electrode active material, or may be composed of an electrode mixture containing a positive electrode active material and, if necessary, a binder and a conductive agent.

Examples of the positive electrode current collector materials include, but are not limited to, aluminum, aluminum alloys, and titanium.

The electrolyte is not particularly limited except that it has lithium ion conductivity, and examples include various solid electrolytes and non-aqueous electrolytes. A preferable non-aqueous electrolyte is composed of a non-aqueous solvent and a lithium salt dissolved therein. The composition of the non-aqueous electrolyte is not particularly limited and may be set suitably according to conventional methods.

Also, the separator and the exterior case are not particularly limited, and various suitable materials used in lithium ion secondary batteries can be used.

The shape of lithium ion secondary batteries to which the electrode for an electrochemical device according to the invention is applicable is not particularly limited, and it is applicable to various shapes such as coin, button, sheet, cylindrical, flat, and prismatic shapes. Also, the electrode group of a lithium ion secondary battery composed of a positive electrode, a negative electrode, and a separator may be of the wound type or the layered type. The battery size is not particularly limited, and the battery may be a small battery for use in a small portable appliance or the like, or may be a large battery for use in an electric vehicle or the like.

The lithium ion secondary batteries using the electrode for an electrochemical device according to the invention are preferable, for example, as the power source for personal digital assistants, portable electronic appliances, small power storage devices for households, two-wheel motor vehicles, electric vehicles, and hybrid electric vehicles.

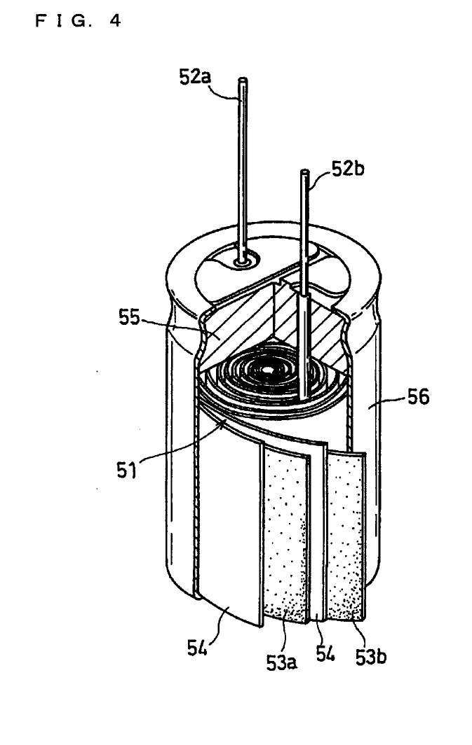

FIG. 4 is a partially cut-away perspective view showing an embodiment of an electrochemical device using the electrode for an electrochemical device according to the invention, in which the electrode for an electrochemical device according to the invention is applied to a polarizable electrode of an electrochemical capacitor.

With reference to FIG. 4, a capacitor device 51 of an electrochemical capacitor includes a pair of polarizable electrodes (a positive electrode 53a and a negative electrode 53b), a separator 54 separating the pair of polarizable electrodes to prevent a short-circuit, and lead wires 52a and 52b connected to the positive electrode 53a and the negative electrode 53b, respectively. The capacitor device 51 is impregnated with an electrolyte (not shown), and is contained in a case 56 together with a seal member 55 with insertion holes through which the lead wire 52a and 52b are inserted. The opening of the case 56 is drawn, so that the seal member 55 is compressed to seal the case 56.

The electrode for an electrochemical device according to the invention is used as the polarizable negative electrode of the above-described electrochemical capacitor. When the electrode for an electrochemical device according to the invention is used as the negative electrode of an electrochemical capacitor, a high capacity can be achieved, compared with the use of a negative electrode made of activated carbon or carbon material. The other constituent components of the electrochemical capacitor than the negative electrode are not particularly limited.

With respect to the polarizable positive electrode, a material with a double layer capacity such as activated carbon, an active material with a pi conjugated bond such as a conductive polymer, etc. are preferable.

When the electrode for an electrochemical device according to the invention is used in an electrochemical capacitor, lithium can be added electrochemically or directly to the electrode for the electrochemical device in order to reduce irreversible capacity. Methods of directly adding lithium include a method of brining lithium metal into contact with an electrode surface and a method of directly depositing lithium by a vacuum process such as vacuum deposition. In this way, adding lithium to the electrode in advance can increase battery capacity.

The separator for the electrochemical capacitor is not particularly limited. For example, a porous film made of polyethylene or polypropylene, a lithium-ion conductive polymer electrolyte membrane, or a solid electrolyte membrane can be used.

The electrolyte is not particularly limited, and examples include electrolytes used in lithium ion secondary batteries. Among them, an electrolyte composed of a non-aqueous solvent and a lithium salt dissolved therein is preferable. It is also possible to mix an ionic liquid thereinto.

When the electrode for an electrochemical device according to the invention is applied to an electrode of an electrochemical capacitor, the resultant electrochemical capacitor can provide an energy density not achieved with a conventional graphite electrode.

### EXAMPLES

The present invention is specifically described below with reference to Examples.

### Example 1

Referring to FIGS. 2A and 2B, a current collector 11 having regularly arranged protrusions 12 on its surface was produced first. In producing the current collector 11, a negative photoresist was applied onto a rolled copper foil of 18 μm in thickness, and the resist film on the copper foil was exposed to light and developed through a negative mask having rhombus patterns. On the grooves thus formed, copper particles were deposited by electrolysis. Thereafter, the resist was removed, and the protrusions 12 each having a rhombus shape in a plan view were formed. The protrusions 12 were formed such that the protrusion height h₁ was 10 μm, the lengths of the long diagonal and the short diagonal of the rhombus portion on the top surface were 28 μm and 12 μm, respectively. The ten-point average height (R₂) of the protrusions 12 measured at the top surface was 0.9 μm.

On the surface of the current collector 11 thus obtained, a thin layer 13 composed of titanium was formed by sputtering. The sputtering conditions were as follows.

### <RF Sputtering Conditions>

Size of substrate: 10 cm×10 cm
Distance between base and target: 7 cm
Gas to be introduced: Ar (25 sccm)
Output power: 1.3 kW
Deposition rate: 1 nm/sec

The thickness of the thin layer 13 was controlled by the duration of deposition, and was adjusted to 0.05 μm (Sample 1), 0.1 μm (Sample 2), and 0.5 μm (Sample 3) to produce three samples.

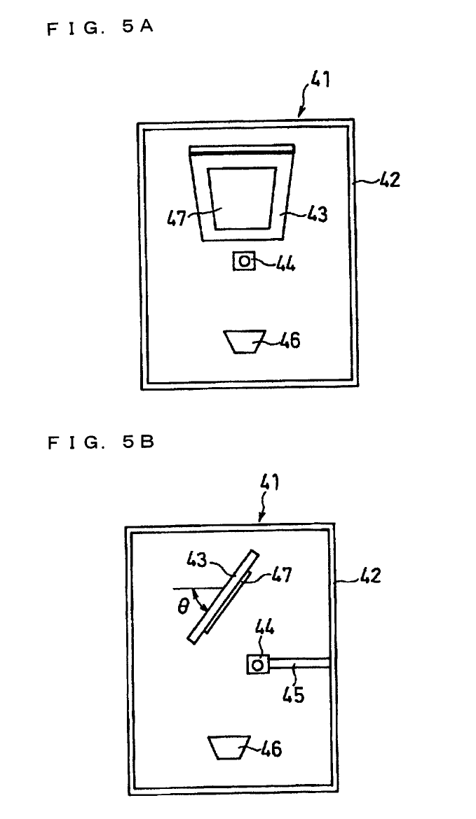

Next, columns 14 composed of an active material were formed on the thin layer 13 on the protrusions 12 on the surface of the current collector 11. In forming the columns 14, a vapor deposition device (available from ULVAC, Inc.) as shown in FIGS. 5A and 5B was used. This vapor deposition device 41 was equipped with an electron beam (not shown) serving as a heating means and further equipped with a pipe 45 for introducing oxygen gas into a chamber 42, and a nozzle 44 connected to the pipe 45. The pipe 45 was connected to an oxygen cylinder via a mass flow controller. A support table 43 for fixing the current collector 11 was disposed above the nozzle 44. A vapor deposition source 46 for forming the active material columns 14 on the surfaces of the protrusions 12 of the current collector 11 was disposed below the support table 43. Silicon with a purity of 99.9999% (available from Kojundo Chemical Lab. Co., Ltd.) was used as the vapor deposition source.

The current collector 11 was fixed on the support table 43 in such a manner that the surface of the current collector 11 on the thin layer 13 side faced the vapor deposition source 46, and the support table 43 was slanted to a position where the angle θ (the angle of slant) formed between the direction n of the normal to the current collector 11 and the vapor deposition direction was 60°.

The acceleration voltage of the electron beam applied to the vapor deposition source 46 was set to −8 kV, and the emission current was set to 250 mA. The duration of vapor deposition was adjusted so that the thickness of the active material layer after vapor deposition was 22 μm.

The vapor of silicon, together with oxygen supplied into the chamber 42, deposited on the copper foil (the negative electrode current collector) placed on the support table 43, forming an active material layer composed of a compound containing silicon and oxygen (silicon oxide). A negative electrode was thus obtained. Such formation of negative electrode was performed for each of the foregoing Samples 1 to 3.

The amount of oxygen contained in the active material layer was determined by a combustion method, and the result showed that the composition of SiOₓ was SiO_{0.7}. The height h₁ of the obtained columns 14 (the thickness of the active material layer) was 20 μm.

### Example 2

A copper foil having protrusions 12 formed in the same manner as in Example 1 was used as the current collector 11, and on the surface of the current collector 11, a 0.1-μm-thick thin layer 13 composed of titanium was formed.

In forming an active material layer, first, an active material was vapor deposited on the surface of the thin layer 13 on the protrusions 12. At this time, the height h₁ of the columns was adjusted to 3 μm. Thereafter, the support table 43 was slanted in the opposite direction to a position where the angle of slant θ was −60°, and vapor deposition of active material was performed under the same conditions as in Example 1, to grow columns 14. The height h₁ of the columns additionally formed was adjusted to 3 μm. Such processes were repeated alternately to perform vapor deposition seven times in total, whereby columns 14 each having six bents were formed.

In the negative electrode thus obtained (Sample 4), the height h₁ of the columns 14 was 21 μm. The composition of SiOₓ was SiO_{0.7}.

### Comparative Example 1

A copper foil prepared in the same manner as in Example 1 was used as the current collector 11. On the protrusions 12 of the current collector 11, no thin layer was formed, and only columns 14 composed of an active material were formed. The vapor deposition conditions for forming the columns 14 were the same as in Example 1. The negative electrode thus obtained was used as Comparative Sample 1.

### Comparative Example 2

A copper foil prepared in the same manner as in Example 1 was used as the current collector 11. Onto the protrusions 12 of the current collector 11, zinc (Zn) plating was applied. Subsequently, columns 14 composed of an active material were formed in the same manner as in Example 1 on the zinc-plated protrusions 12 of the current collector 11. The negative electrode thus obtained was used as Comparative Sample 2.

Physical Property Evaluation 1

With respect to the negative electrodes obtained in the above, the adhesive strength between the current collector 11 and the active material was measured with a tacking tester (TAC-II Available from Rhesca Co., Ltd.)

In measuring the adhesive strength, a double-coated tape (No. 515 available from NITTO DENKO CORPORATION) was attached at the tip end of the measurement probe (tip end diameter: 2 mm), and the measurement was performed under the conditions of a push-in speed of 30 mm/min, a push-in duration of 10 sec, a load of 400 gf, and a pull-up speed of 600 mm/min. The negative electrode plate was cut into a size of 2 cm in width and 3 cm in length, and was pasted and fixed at a position facing the measurement probe with the foregoing double-coated tape.

Physical Property Evaluation 2

A coin battery was fabricated using the negative electrode of Sample 1 obtained in Example 1 and a counter electrode made of metal lithium.

First, a 300-μm-thick metal lithium (a counter electrode) was punched in the shape of a disc of 15 μm in diameter and pasted onto a seal plate. A 20-μm-thick microporous separator made of polyethylene (available from Asahi Kasei Corporation) was disposed on the surface of the counter electrode, and on the surface of the separator, the negative electrode (Sample 1) formed into the shape of a disc of 12.5 mm in diameter was disposed.

Separately from the above, ethylene carbonate, ethyl methyl carbonate and diethyl carbonate were mixed in a ratio of 3:5:2 by volume, and LiPF₆ was added to the resultant mixed solvent at a concentration of 1.2 M, to give an electrolyte solution. The electrolyte solution thus obtained was dropped to a laminate of the foregoing counter electrode, separator, and negative electrode. Further, a 100-μm-thick stainless steel plate was disposed on the surface of the negative electrode in order to adjust the overall thickness, and a case was placed thereon and then sealed with a crimping machine.

Coin batteries including the negative electrodes of Samples 2 to 4 and the negative electrodes of Comparative Samples 1 and 2 were also fabricated in the same manner as described above.

The fabricated coin batteries were subjected to a charge/discharge test performed under the following conditions.

Charge: Constant-current charge at 0.1 mA, End-of-charge voltage 0 V, Interval between charge and discharge 30 min

Discharge: Constant-current discharge at 0.1 mA, End-of-discharge voltage 1.5 V

The charge/discharge test was performed under the above conditions to measure the irreversible capacity at the first cycle. Further, the coin batteries were disassembled and observed to check whether separation of active material occurred or not.

The results of the physical property evaluations 1 and 2 are shown in Table 1.

TABLE 1

| | | | Physical property evaluation | | |
|---|---|---|---|---|---|
| Negative | Thin layer | | Adhesive | Irreversible | Separation |
| electrode | | Thickness | strength | capacity ratio | of active |
| Sample No. | Component | (mm) | (kgf/cm²) | (%) | material |
| Sample 1 | Ti | 0.05 | >30 | 33 | Not occurred |
| Sample 2 | Ti | 0.1 | >30 | 30 | Not occurred |
| Sample 3 | Ti | 0.5 | >30 | 32 | Not occurred |
| Sample 4 | Ti | 0.1 | >30 | 30 | Not occurred |
| Comparative | Without | — | 22 | 74 | Occurred |
| Sample 1 | | | | | |
| Comparative | Zn | 0.05 | 15 | 84 | Occurred |
| Sample 2 | | | | | |

The adhesive strengths of the negative electrodes of Samples 1 to 4 were 30 kgf/cm² or more. The adhesive strength of the negative electrode of Comparative Sample 1 was 22 kgf/cm². These results show that the adhesive strength is significantly improved by forming a thin layer 13 composed of Ti.

It has been already confirmed by the inventors that in the active material having a composition of SiO_{0.7} of Examples, the irreversible capacity amounts to about 30 to 35%. Since the coin batteries including Samples 1 to 4 exhibited almost the same level of irreversible capacity, it was confirmed that according to Samples 1 to 4, the active material was efficiently utilized.

In contrast, the irreversible capacities of Comparative Samples 1 and 2 were extremely high. When the active material layer after battery charge/discharge was observed with an electron microscope, the occurrence of separation of active material was observed in Comparative Samples 1 and 2, which is considered to be the cause of the increase in irreversible capacity.

Based on the foregoing results, it was confirmed that by forming on the surface of a current collector a thin layer composed of a transition metal with a polarizability higher than that of the component of the current collector, the adhesion between the active material layer and the thin layer was improved, and thus the separation of active material due to charge/discharge was prevented.

It should be noted that in Comparative Sample 2 including a thin layer composed of zinc with a polarizability lower than the current collector 11, the adhesive strength between the active material layer and the thin layer was reduced, and the electrochemical characteristics were degraded.

### INDUSTRIAL APPLICABILITY

The electrode of the present invention is applicable to various forms of lithium ion secondary batteries and electrochemical capacitors, and is particularly useful in a lithium ion secondary battery and an electrochemical capacitor for which a high capacity and good cycle characteristics are required.

1. An electrode for an electrochemical device, comprising a current collector, a thin layer formed on at least a part of a surface of the current collector, and an active material layer formed on a surface of the thin layer,
wherein the active material layer comprises an active material that does not form a chemical bond with a component forming the current collector, and the active material comprises one selected from the group consisting of oxides, nitrides and carbides of silicon, and oxides, nitrides and carbides of tin, and
the thin layer consists essentially of a component with a polarizability higher than that of the component forming the current collector.

2. (canceled)

3. The electrode for an electrochemical device in accordance with claim 1, wherein the active material layer is composed of an oxide of silicon represented by the formula: SiOₓ where 0<x<1.2 and x represents an atomic ratio of oxygen.

4. The electrode for an electrochemical device in accordance with claim 1, wherein the active material layer is composed of an oxide of tin represented by the formula: SnO_{y} where 0<y<2 and y represents an atomic ratio of oxygen.

5. The electrode for an electrochemical device in accordance with claim 1, wherein the current collector is composed of copper, a copper alloy, nickel, a nickel alloy, or stainless steel.

6. The electrode for an electrochemical device in accordance with claim 1, wherein the current collector is composed of copper or a copper alloy, and the component of the thin layer with a polarizability higher than that of the component forming the current collector is a metal or an alloy of two or more metals selected from the group consisting of Ti, Ni, Co, Fe, Mn, Cr, V, Sc, Y, Zr, and Rh.

7. The electrode for an electrochemical device in accordance with claim 1, wherein the current collector is composed of nickel or a nickel alloy, and the component of the thin layer with a polarizability higher than that of the component forming the current collector is a metal or an alloy of two or more metals selected from the group consisting of Cr, V, Ti, Y, Zr, Nb, and Sc.

8. The electrode for an electrochemical device in accordance with claim 1, wherein the current collector is composed of stainless steel, and the component of the thin layer with a polarizability higher than that of the component forming the current collector is a metal or an alloy of two or more metals selected from the group consisting of V, Ti, Y, Zr, Nb, and Sc.

9. The electrode for an electrochemical device in accordance with claim 3, wherein the current collector is composed of copper, and the thin layer is composed of titanium.

10. The electrode for an electrochemical device in accordance with claim 1, wherein the current collector has a plurality of protrusions on the surface thereof.

11. The electrode for an electrochemical device in accordance with claim 1, wherein the active material layer comprises columns of the active material carried on the protrusions on the surface of the current collector.

12. The electrode for an electrochemical device in accordance with claim 11, wherein the columns of the active material are slanted relative to a direction of a normal to the surface of the current collector.

13. The electrode for an electrochemical device in accordance with claim 10, wherein the protrusions are evenly spaced on the surface of the current collector and regularly arranged.

14. A lithium ion secondary battery comprising a positive electrode, a negative electrode, a separator separating the positive electrode and the negative electrode, and a non-aqueous electrolyte, wherein one of the positive electrode and the negative electrode is the electrode of claim 1.

15. An electrochemical capacitor comprising at least a pair of polarizable electrodes, a separator separating the adjacent polarizable electrodes, and an electrolyte between the polarizable electrodes, wherein one of the polarizable electrodes is the electrode of claim 1.
